(19) United States
(12) Patent Application Publication
(10) Pub. No.: US 2026/0121451 A1
(43) Pub. Date: Apr. 30, 2026

(54) HIGH-HEAT-DISSIPATION ULTRA-THIN WIRELESS CHARGER

(71) Applicant: GOPOD GROUP HOLDING LIMITED., SHENZHEN (CN)

(72) Inventors: Zhuowen LIAO, SHENZHEN (CN); Xingwang SONG, SHENZHEN (CN); Long MIAO, SHENZHEN (CN)

(21) Appl. No.: 19/009,994

(22) Filed: Jan. 4, 2025

(30) Foreign Application Priority Data
Oct. 31, 2024 (CN) 202411555940.7

(51) Int. Cl. H02J 50/00; H02J 50/10

(52) U.S. Cl. CPC H02J 50/005; H02J 50/10

(57) ABSTRACT

Embodiment of the application relates to the technical field of wireless charging, and discloses a high-heat-dissipation ultra-thin wireless charger. The wireless charger comprises a shell, a shell being provided with a vent; a supporting plate arranged inside the shell, the supporting plate being a thin sheet with a certain area, one surface of the supporting plate being attached with a charging coil, and the other surface of the supporting plate being attached with a PCB board and fan blades; and the fan blades used for rotating under control of the PCB board and driving air in the shell to flow while rotating; and the air in the shell passing through the PCB board under driving of the fan blades and then flowing out through the vent. The embodiment of the application improves a heat dissipation effect of the wireless charger while reducing a thickness of the wireless charger.

### TECHNICAL FIELD

The present application relates to the technical field of wireless charging, and particularly discloses a high-heat-dissipation ultra-thin wireless charger.

### BACKGROUND OF THE PRESENT INVENTION

With the progress of science and technology and the improvement of people's living standards, people use electronic devices more and more widely, and the convenience of charging mode of the electronic devices has also attracted much attention. In the prior art, a wireless charger is usually used to realize the convenience of charging of the electronic devices.

In order to meet the heat dissipation requirement of the wireless charger, more and more wireless chargers are equipped with a heat dissipation fan, so that a thickness of the wireless charger is generally greater than 12 mm, wherein a thickness of a relatively thin wireless charger is maintained at 10 mm to 12 mm. Therefore, there is still room for improvement in a thickness of an existing wireless charger. Moreover, fan blades of the existing wireless charger mainly blow external wind to a shell of the wireless charger to cool a charging coil in the wireless charger and a charged electronic device. However, this heat dissipation mode may cause heat accumulation inside the shell. Therefore, there is still room for improvement in a heat dissipation performance of the existing wireless charger.

To sum up, how to reduce the thickness of the wireless charger while improving the heat dissipation performance of the wireless charger has become an urgent technical problem.

### SUMMARY OF THE PRESENT INVENTION

In view of the above problem, an embodiment of the present application provides a high-heat-dissipation ultra-thin wireless charger for improving a heat dissipation effect of the wireless charger while reducing a thickness of the wireless charger.

In one aspect of the embodiment of the present application, a high-heat-dissipation ultra-thin wireless charger is provided, and the wireless charger comprises: a shell, wherein the shell is provided with a vent; a supporting plate arranged inside the shell, wherein the supporting plate is a thin sheet with a certain area, one surface of the supporting plate is attached with a charging coil, and the other surface of the supporting plate is attached with a PCB board and fan blades; and the fan blades used for rotating under control of the PCB board and driving air in the shell to flow while rotating; wherein, the air in the shell passes through the PCB board under driving of the fan blades and then flows out through the vent.

Preferably, the vent comprises an air inlet and a plurality of air outlets; the PCB board is in an annular structure, and the fan blades are arranged on an inner ring of the annular structure; the air inlet is aligned with the inner ring of the annular structure, and the plurality of air outlets are aligned with the PCB board and distributed around an edge of the PCB board; edges of the fan blades are perpendicular to a rotation plane formed by the rotation of the fan blades; and under the rotation of the fan blades, air outside the shell passes through the air inlet and then flows into the shell, and air inside the shell passes through the PCB board and then flows out of the shell through the plurality of air outlets.

Preferably, the wireless charger further comprises a motor, and the motor is fixed on one surface of the supporting plate attached with the PCB board; the motor comprises an output shaft, the fan blades are fixed on the output shaft, and the output shaft is perpendicular to a board surface of the PCB board, and used for driving the fan blades to rotate to form the rotation plane; and the rotation plane formed by the rotation of the fan blades is located in a same plane as the board surface of the PCB board.

Preferably, the other surface of the supporting plate is provided with a cylindrical mounting portion, the mounting portion is arranged at the inner ring of the annular structure, and the motor is sleeved in the mounting portion.

Preferably, the motor is embedded in the supporting plate, and the output shaft of the motor protrudes from a plate surface of the supporting plate, and is connected with the fan blades.

Preferably, the PCB board is used for generating a control signal and sending the control signal to the motor, so as to control an output of the motor; one surface of the supporting plate attached with the PCB board is sunken to form a first wiring region; and the wireless charger further comprises a wire, the wire is fixed in the first wiring region, one end of the wire is electrically connected with the PCB board, the other end of the wire is electrically connected with the motor, and the wire is used for transmitting the control signal from the PCB board to the motor.

Preferably, an edge of one surface of the supporting plate attached with the PCB board is sunken to form a second wiring region; the shell comprises a bottom shell and a face shell, and the face shell covers one surface of the supporting plate attached with the charging coil; and the bottom shell covers one surface of the supporting plate attached with the PCB board, the bottom shell is provided with a charging port, the charging port is aligned with the second wiring region, and the second wiring region is used for connecting an external power supply to the PCB board.

Preferably, a shell surface of the bottom shell has a certain area, a side wall of the bottom shell has a certain height, the air inlet is arranged in the shell surface of the bottom shell and has a certain area, and the plurality of air outlets are arranged in the side wall of the bottom shell.

Preferably, the wireless charger further comprises a magnet block, the magnet block is arranged between the face shell and the supporting plate, and the face shell and the supporting plate form a clamping force for the magnet block.

Preferably, a barrier strip protrudes from one surface of the supporting plate, the charging coil is located on one side of the barrier strip and distributed close to a center of the supporting plate, and the magnet block is located on the other opposite side of the barrier strip and distributed close to the edge of the supporting plate; and the barrier strip is connected end to end to form a ring shape, and an outer coil side of the charging coil is clamped in the barrier strip.

According to the embodiment of the present application, by attaching one surface of the supporting plate with the charging coil and attaching the other surface of the supporting plate with the PCB board and the fan blades, there is no need to separately arranging a supporting frame for the charging coil, the PCB board and the fan blades inside the wireless charger, which can save a plurality of supporting frames, thus reducing the thickness of the wireless charger; in addition, the air in the shell is arranged to pass through the PCB board under the driving of the fan blades and then flow out through the vent, so that heat of the PCB board can be directly dissipated by the fan blades; and one surface of the supporting plate is attached with the charging coil, so that heat generated by the charging coil when in use can be efficiently transferred to the supporting plate, and the other surface of the supporting plate is attached with the PCB board, so that heat of the supporting plate can be efficiently transferred to the PCB board, and then heat of the PCB board is directly dissipated by the fan blades. Therefore, the heat generated by the charging coil and the heat generated by the PCB board are taken out of the shell of the wireless charger together through the vent, which avoids the heat from being concentrated in the shell, thus greatly improving the heat dissipation performance of the wireless charger.

The above description is only an overview of the technical solution of the present application. In order to understand the technical means of the present application more clearly, the present application can be implemented according to the contents of the specification, and in order to make the above and other objectives, features and advantages of the present application more obvious and understandable, specific embodiments of the present application are listed hereinafter.

### DESCRIPTION OF THE DRAWINGS

By reading the following detailed descriptions of preferred embodiments, various other advantages and benefits will be clear to those of ordinary skills in the art. The drawings are only for the purpose of illustrating the preferred embodiments, and are not considered as limiting the present application. Moreover, in all the drawings, the same reference numerals are used to indicate the same parts. In the drawings:

FIG. 1 is a stereoscopic diagram of a wireless charger provided by an embodiment of the present application;

FIG. 2 is a stereoscopic diagram of the wireless charger provided by the embodiment of the present application from another perspective;

FIG. 3 is a diagram of an internal structure of the wireless charger provided by the embodiment of the present application; and

FIG. 4 is an exploded view of the wireless charger provided by the embodiment of the present application.

Reference numerals in specific embodiments are as follows:
1 refers to wireless charger;
10 refers to shell; 11 refers to face shell; and 12 refers to bottom shell;
13 refers to vent; 131 refers to air inlet; 132 refers to air outlet; and 133 refers to charging port;
21 refers to magnet block; 22 refers to charging coil; and 23 refers to barrier strip;
30 refers to supporting plate; 31 refers to mounting portion; 32 refers to first wiring region; and 33 refers to second wiring region;
40 refers to PCB board; 50 refers to motor; and 60 refers to fan blade.

### DETAILED DESCRIPTION OF PREFERRED EMBODIMENTS

Embodiments of technical solutions of the present application are described in detail hereinafter with reference to the drawings. The following embodiments are only used to illustrate the technical solutions of the present application more clearly, so that the embodiments are only used as examples, and cannot be used to limit the scope of protection of the present application.

Unless otherwise defined, all technical and scientific terms used herein have the same meanings as commonly understood by those skilled in the technical field of the present application; the terms used herein are only for the purpose of describing specific embodiments and are not intended to limit the present application; and the terms “comprise” and “have” as well as any variations thereof in the specification and the claims of the present application and the description of the drawings above are intended to cover non-exclusive inclusion.

In the descriptions of the embodiments of the present application, the technical terms “first”, “second” and the like are only used for distinguishing different objects, and cannot be understood as indicating or implying relative importance, or implicitly indicating the number, specific sequence or primary-secondary relationship of the indicated technical features. In the descriptions of the embodiments of the present application, the meaning of “multiple” is more than two, unless otherwise specifically defined.

The “embodiment” mentioned herein means that the specific features, structures or performances described with reference to the embodiment may be included in at least one embodiment of the present application. The appearance of this phrase in various places in the specification does not necessarily refer to the same embodiment, nor is it an independent or alternative embodiment mutually exclusive with other embodiments. It is understood explicitly and implicitly by those skilled in the art that the embodiments described herein may be combined with other embodiments.

In the descriptions of the embodiments of the present application, the term “and/or” describes a relationship between related objects, and indicates that there may be three relationships. For example, A and/or B, may indicate that: A exists alone, A and B exist at the same time, and B exists alone. In addition, the symbol “/” herein generally indicates that there is a relationship of “or” between the related objects.

In the descriptions of the embodiments of the present application, the term “multiple” refers to being more than two (comprising two), and similarly, “multiple groups” refers to being more than two groups (comprising two groups), and “multiple pieces” refers to being more than two pieces (comprising two pieces).

In the descriptions of the embodiments of the present application, the orientation or position relationship indicated by the technical terms “center”, “longitudinal”, “transverse”, “length”, “width”, “thickness”, “up”, “down”, “front”, “rear”, “left”, “right”, “vertical”, “horizontal”, “top”, “bottom”, “inside”, “outside”, “clockwise”, “counter-clockwise”, “axial”, “radial”, “circumferential”, and the like is based on the orientation or position relationship shown in the drawings, it is only for the convenience of description of the embodiments of the present application and simplification of the description, and it is not to indicate or imply that the indicated device or element must have a specific orientation, and be constructed and operated in a specific orientation. Therefore, the terms should not be understood as limiting the embodiments of the present application.

In the descriptions of the embodiments of the present application, the technical terms “installation”, “connected”, “connection”, “fixation”, and the like should be understood in broad sense unless otherwise specified and defined. For example, they may be fixed connection, removable connection or integrated connection; may also be mechanical connection or electrical connection; and may be direct connection, or indirect connection through an Embodiment Description intermediate medium, and connection inside two components, or interaction relation of two elements. The specific meanings of the above terms in the embodiments of the present application may be understood in a specific case by those of ordinary skills in the art.

The present application is suitable for wirelessly charging an electronic device, such as an iPhone.

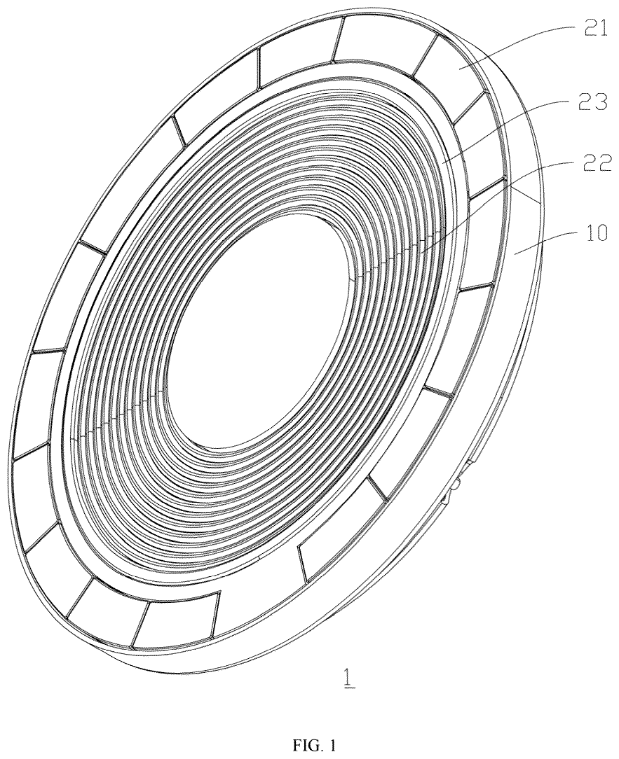

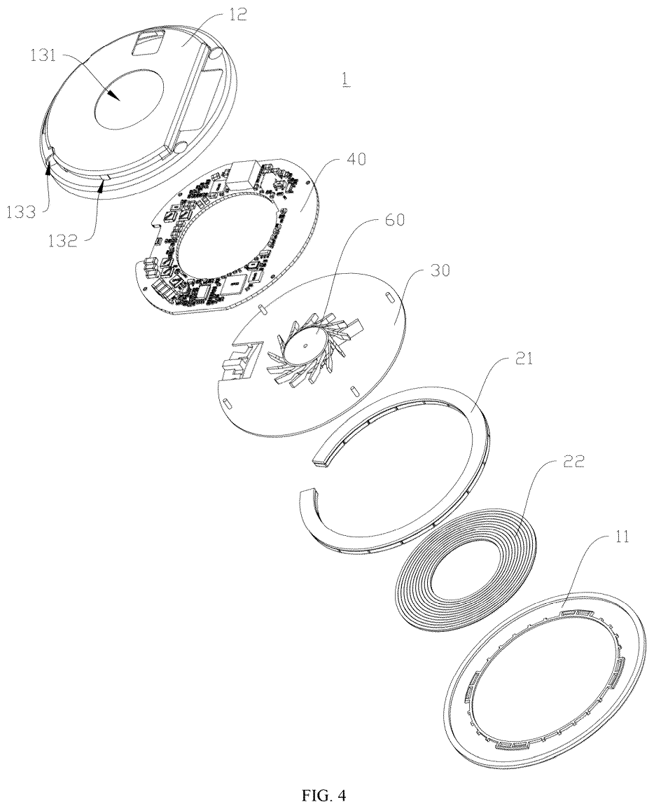

An embodiment of the present application provides a high-heat-dissipation ultra-thin wireless charger. With reference to FIG. 1 to FIG. 4, the wireless charger 1 comprises: a shell 10, wherein the shell 10 is provided with a vent 13; a supporting plate 30 arranged inside the shell 10, wherein the supporting plate 30 is a thin sheet with a certain area, one surface of the supporting plate 30 is attached with a charging coil 22, and the other surface of the supporting plate is attached with a PCB board (Printed Circuit Board) and fan blades 60; and the fan blades 60 used for rotating under control of the PCB board 40 and driving air in the shell 10 to flow while rotating; wherein, the air in the shell 10 passes through the PCB board 40 under driving of the fan blades 60 and then flows out through the vent 13.

There is no protective shell outside the fan blades 60, so that the fan blades are exposed on the supporting plate 30; and further, the fan blades 60 may be an integral part with the supporting plate 30, or the fan blades and the supporting plate may also be two separable parts.

A ventilation and heat dissipation channel is formed in the shell 10. Specifically, the vent 13 comprises an air inlet 131 and a plurality of air outlets 132; the PCB board 40 is in an annular structure, and the fan blades 60 are arranged on an inner ring of the annular structure; the air inlet 131 is aligned with the inner ring of the annular structure, and the plurality of air outlets 132 are aligned with the PCB board 40 and distributed around an edge of the PCB board 40; and under the rotation of the fan blades 60, air outside the shell 10 passes through the air inlet 131 and then flows into the shell 10, and air inside the shell 10 passes through the PCB board 40 and then flows out of the shell 10 through the plurality of air outlets 132.

Preferably, an edge of one surface of the supporting plate 30 attached with the PCB board 40 is sunken to form a second wiring region 33; the shell 10 comprises a bottom shell 12 and a face shell 11, and the face shell 11 covers one surface of the supporting plate 30 attached with the charging coil 22; and the bottom shell 12 covers one surface of the supporting plate 30 attached with the PCB board 40, the bottom shell 12 is provided with a charging port 133, the charging port 133 is aligned with the second wiring region 33, and the second wiring region 33 is used for connecting an external power supply to the PCB board 40.

Preferably, a shell surface of the bottom shell 12 has a certain area, a side wall of the bottom shell 12 has a certain height, the air inlet 131 is arranged in the shell surface of the bottom shell 12 and has a certain area, and the plurality of air outlets 132 are arranged in the side wall of the bottom shell 12.

Preferably, the wireless charger 1 further comprises a magnet block 21, the magnet block 21 is arranged between the face shell 11 and the supporting plate 30, and the face shell 11 and the supporting plate 30 form a clamping force for the magnet block 21.

Preferably, the PCB board 40 is in a standard ring structure, and an inner circle part of the ring structure corresponds to the inner ring of the annular structure.

When the electronic device is charged, the electronic device is attached to the face shell 11, the charging coil 22 is controlled after the PCB board 40 senses the electronic device, the charging coil 22 generates an electromagnetic signal under control of the PCB board 40, and the electronic device is charged by an electromagnetic wave induction principle.

When the wireless charger 1 is used, one part of heat in the wireless charger 1 is generated by the charging coil 22, and the other part of heat is generated by the PCB board 40. In addition, the electronic device may also generate heat during wireless charging, and transfer the heat to the face shell 11.

As for the heat in the wireless charger 1, the fan blades 60 directly dissipate the heat of the PCB board 40, so that the heat in the wireless charger 1 is quickly transferred to the PCB board 40, and the fan blades 60 rapidly dissipate the heat of the PCB board 40.

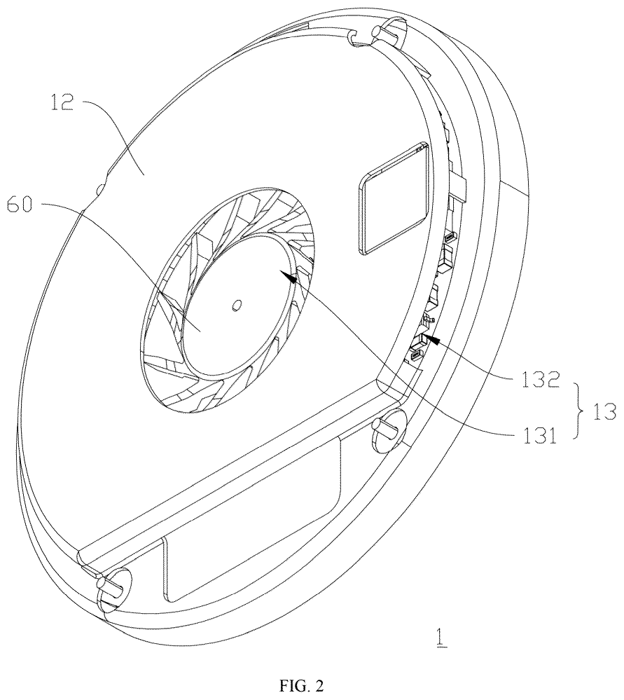

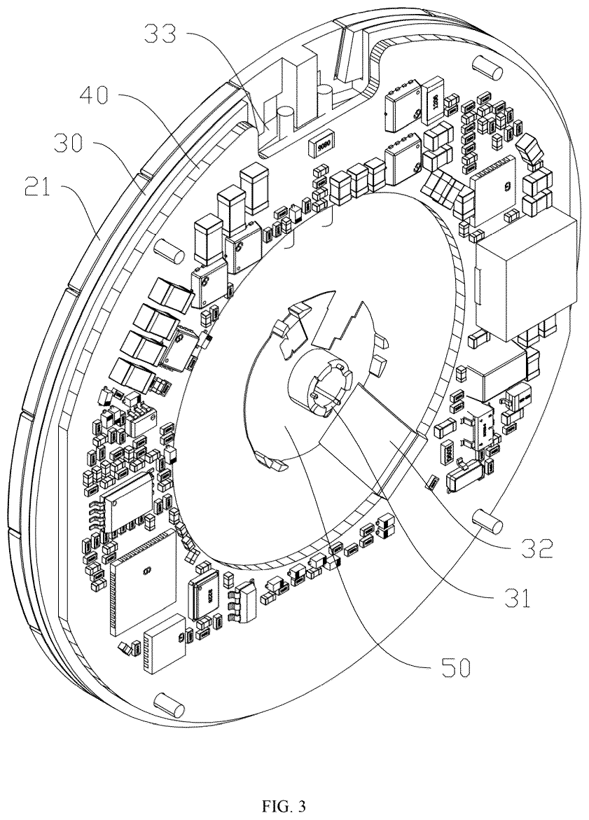

Specifically, with reference to FIG. 2 and FIG. 3, edges of the fan blades 60 are perpendicular to a rotation plane formed by the rotation of the fan blades 60, so that a front face of the rotation plane of the fan blades 60 is an air inlet face, and a side face opposite to the rotation plane is an air outlet face; and the PCB board 40 is in the annular structure, and the fan blades 60 are arranged on the inner ring of the annular structure, so that components generating heat on the PCB board 40 are located on the air outlet face of the fan blades 60. That is, under the rotation of the fan blades 60, low-temperature wind outside the shell 10 passes through the air inlet 131 and then enters the shell 10, so that the low-temperature wind flowing into the shell 10 will blow over the PCB board 40 under driving of the fan blades 60. Therefore, the heat of the components on the PCB board 40 is transferred to the low-temperature wind, a temperature of the low-temperature wind is increased, and the low-temperature wind carries the heat of the PCB board 40 to pass through the air outlet 132 and then flow out of the shell 10, so as to dissipate the heat of the PCB board 40 through the fan blades 60.

With reference to FIG. 3, when the heat of the PCB board 40 is quickly dissipated through the fan blades 60, a temperature difference is formed between the PCB board 40 and the charging coil 22. By attaching and fixing the charging coil 22 to the supporting plate 30, the heat of the charging coil 22 may be quickly transferred to the supporting plate 30, and by fixing and attaching the PCB board 40 to the supporting plate 30, the heat of the supporting plate 30 may be quickly transferred to the PCB board 40, and then the heat of the PCB board 40 is dissipated through the fan blades 60, thus realizing simultaneous heat dissipation of a plurality of heating structures in the wireless charger 1 through the fan blades 60.

Further, considering the heat transferred from the electronic device to the face shell 11, one part of the heat may be directly transferred to external low-temperature air, the other part of the heat may also be transferred to the PCB board 40, and the heat is dissipated through the fan blades 60.

Therefore, the wireless charger 1 may have an extremely high heat dissipation performance.

A specific heat dissipation performance of a wireless charger in the prior art may refer to Table 1, and the specific heat dissipation performance of the wireless charger 1 provided by the embodiment of the present application may refer to Table 2. A test environment of Table 1 and Table 2 is an environment at 25° C. room temperature. The wireless charger in the prior art and the wireless charger 1 provided by the embodiment of the present application are respectively placed on a wooden table to charge a mobile phone (which is not provided with a mobile phone shell and is placed in a center position), the sample mobile phone is an iPhone with a rated input of 15 V and an output fixture of 25 w, and data are measured when a temperature curve is stable after aging.

It can be found from Table 1 that an actual temperature of the wireless charger in the prior art is generally above 55° C. during charging; and it can be found from Table 2 that an actual temperature of the wireless charger 1 provided by the present application is generally below 40° C. during charging.

TABLE 1

| | Shell | Shell | Shell | Shell | Shell | Shell | Shell | Environment |
|---|---|---|---|---|---|---|---|---|
| Name of component | 1 | 2 | 3 | 4 | 5 | 6 | 7 | temperature |
| Temperature limit value ° C. | 45 | 45 | 45 | 45 | 45 | 45 | 45 | 25 |
| Actual temperature ° C. | 68.8 | 74.5 | 68.7 | 64.8 | 69.4 | 63.7 | 58.8 | 27 |
| Determination | FAIL | FAIL | FAIL | FAIL | FAIL | FAIL | FAIL | NA |

TABLE 2

| | Shell | Shell | | Shell | Shell | Shell | Shell | Shell | Environment |
|---|---|---|---|---|---|---|---|---|---|
| Name of component | 1 | 2 | 4.7UH | 4 | 5 | 6 | 7 | 8 | temperature |
| Temperature limit value ° C. | 45 | 45 | 65 | 45 | 45 | 45 | 45 | 45 | 25 |
| Actual temperature ° C. | 35.2 | 40.2 | 41.4 | 36.1 | 33.7 | 34.7 | 33.4 | 35.8 | 26.7 |
| Determination | PASS | PASS | PASS | PASS | PASS | PASS | PASS | PASS | NA |

In order to reduce a thickness of the wireless charger 1, the supporting plate 30 may be the thin sheet with the certain area, one surface of the supporting plate 30 is attached with the charging coil 22, and the other surface of the supporting plate is attached with the PCB board (Printed Circuit Board) and the fan blades 60. Further, the edge of one surface of the supporting plate 30 attached with the PCB board 40 is sunken to form the second wiring region 33, so as to reduce a space thickness required for wiring.

Preferably, the PCB board 40 is used for generating a control signal and sending the control signal to the motor 50, so as to control an output of the motor 50; one surface of the supporting plate 30 attached with the PCB board 40 is sunken to form a first wiring region 32; and the wireless charger 1 further comprises a wire, the wire is fixed in the first wiring region 32, one end of the wire is electrically connected with the PCB board 40, the other end of the wire is electrically connected with the motor 50, and the wire is used for transmitting the control signal from the PCB board 40 to the motor 50.

Similarly, one surface of the supporting plate 30 attached with the PCB board 40 is sunken to form the first wiring region 32, which can also reduce the space thickness required for wiring.

Preferably, a barrier strip 23 protrudes from one surface of the supporting plate 30, the charging coil 22 is located on one side of the barrier strip 23 and distributed close to a center of the supporting plate 30, and the magnet block 21 is located on the other opposite side of the barrier strip 23 and distributed close to the edge of the supporting plate 30; and the barrier strip 23 is connected end to end to form a ring shape, and an outer coil side of the charging coil 22 is clamped in the barrier strip 23.

By attaching the magnet block 21 and the charging coil 22 to one surface of the supporting plate 30, and attaching the PCB board and the fan blades 60 to the other surface of the supporting plate, a plurality of supporting frame structures are combined into one supporting plate 30, so as to greatly reduce the thickness of the wireless charger 1.

Preferably, the wireless charger 1 further comprises a motor 50, and the motor 50 is fixed on one surface of the supporting plate 30 attached with the PCB board 40; the motor 50 comprises an output shaft, the fan blades 60 are fixed on the output shaft, and the output shaft is perpendicular to a board surface of the PCB board 40, and used for driving the fan blades 60 to rotate to form the rotation plane; and the rotation plane formed by the rotation of the fan blades 60 is located in a same plane as the board surface of the PCB board 40.

By setting the PCB board 40 to be in the annular structure, and arranging the fan blades 60 on the inner ring of the annular structure, the rotation plane formed by the rotation of the fan blades 60 may be located in the same plane as the board surface of the PCB board, so as to reduce the space thickness occupied by the fan blades 40.

By allowing one surface of the supporting plate 30 attached with the PCB board 40 to be sunken to form the first wiring region 32, the space thickness required for wiring can also be reduced.

As shown in FIG. 3, the other surface of the supporting plate 30 is provided with a cylindrical mounting portion 31, the mounting portion 31 is arranged at the inner ring of the annular structure, and the motor 50 is sleeved in the mounting portion 31, so as to improve the stability of the motor 50. Alternatively, the motor 50 is embedded in the supporting plate 30, and the output shaft of the motor 50 protrudes from the plate surface of the supporting plate 30, and is connected with the fan blades 60, so as to reduce the space thickness occupied by the motor 50.

According to the embodiment of the present application, by setting the supporting plate 30 to be the thin sheet with the certain area, attaching one surface of the supporting plate 30 with the charging coil 22 and attaching the other surface of the supporting plate with the PCB board and the fan blades 60, the plurality of supporting frame structures are combined into one supporting plate 30, so that actual data show that the thickness of the wireless charger 1 ranges from 6.7 mm to 6.8 mm, thus greatly reducing the thickness of the wireless charger 1; by arranging the air in the shell 10 to pass through the PCB board 40 under the driving of the fan blades 60 and then flow out through the vent 13, heat of the PCB board 40 can be directly dissipated by the fan blades 60; and one surface of the supporting plate 30 is attached with the charging coil 22, so that heat generated by the charging coil 22 when in use can be efficiently transferred to the supporting plate 30, and the other surface of the supporting plate 30 is attached with the PCB board 40, so that heat of the supporting plate 30 can be efficiently transferred to the PCB board 40, and then heat of the PCB board 40 is directly dissipated by the fan blades 60. Therefore, the heat generated by the charging coil 22 and the heat generated by the PCB board 40 are taken out of the shell 10 of the wireless charger 1 together through the vent 13, which avoids the heat from being concentrated in the shell 10, thus greatly improving the heat dissipation performance of the wireless charger 1.

Finally, it should be noted that: the embodiments above are only used to illustrate the technical solutions of the present application, and are not intended to limit the present application. Although the present application has been described in detail with reference to the above-mentioned embodiments, those of ordinary skills in the art should understand that: the technical solutions recorded in the above-mentioned embodiments can still be modified, or equivalent substitutions can be made to a part or all of the technical features in the embodiments. However, these modifications or substitutions do not make the essence of the corresponding technical solutions deviate from the scope of the technical solutions of the embodiments of the present application, and should be all included in the scope of the claims and the specification of the present application. In particular, as long as there is no structural conflict, the technical features mentioned in the embodiments can be combined in any way. The present application is not limited to the specific embodiments disclosed herein, but comprises all technical solutions falling within the scope of the claims.

We claim:

1. A high-heat-dissipation ultra-thin wireless charger, comprising:
a shell, wherein the shell is provided with a vent;
a supporting plate arranged inside the shell, wherein the supporting plate is a thin sheet with a certain area, one surface of the supporting plate is attached with a charging coil, and the other surface of the supporting plate is attached with a PCB board and fan blades; and
the fan blades used for rotating under control of the PCB board and driving air in the shell to flow while rotating;
wherein, the air in the shell passes through the PCB board under driving of the fan blades and then flows out through the vent.

2. The wireless charger according to claim 1, wherein the vent comprises an air inlet and a plurality of air outlets;
the PCB board is in an annular structure, and the fan blades are arranged on an inner ring of the annular structure;
the air inlet is aligned with the inner ring of the annular structure, and the plurality of air outlets are aligned with the PCB board and distributed around an edge of the PCB board;
edges of the fan blades are perpendicular to a rotation plane formed by the rotation of the fan blades; and
under the rotation of the fan blades, air outside the shell passes through the air inlet and then flows into the shell, and air inside the shell passes through the PCB board and then flows out of the shell through the plurality of air outlets.

3. The wireless charger according to claim 2, wherein the wireless charger further comprises a motor, and the motor is fixed on one surface of the supporting plate attached with the PCB board;
the motor comprises an output shaft, the fan blades are fixed on the output shaft, and the output shaft is perpendicular to a board surface of the PCB board, and used for driving the fan blades to rotate to form the rotation plane; and
the rotation plane formed by the rotation of the fan blades is located in a same plane as the board surface of the PCB board.

4. The wireless charger according to claim 3, wherein the other surface of the supporting plate is provided with a cylindrical mounting portion, the mounting portion is arranged at the inner ring of the annular structure, and the motor is sleeved in the mounting portion.

5. The wireless charger according to claim 3, wherein the motor is embedded in the supporting plate, and the output shaft of the motor protrudes from a plate surface of the supporting plate, and is connected with the fan blades.

6. The wireless charger according to claim 3, wherein the PCB board is used for generating a control signal and sending the control signal to the motor, so as to control an output of the motor;
one surface of the supporting plate attached with the PCB board is sunken to form a first wiring region; and
the wireless charger further comprises a wire, the wire is fixed in the first wiring region, one end of the wire is electrically connected with the PCB board, the other end of the wire is electrically connected with the motor, and the wire is used for transmitting the control signal from the PCB board to the motor.

7. The wireless charger according to claim 3, wherein an edge of one surface of the supporting plate attached with the PCB board is sunken to form a second wiring region;
the shell comprises a bottom shell and a face shell, and the face shell covers one surface of the supporting plate attached with the charging coil; and
the bottom shell covers one surface of the supporting plate attached with the PCB board, the bottom shell is provided with a charging port, the charging port is aligned with the second wiring region, and the second wiring region is used for connecting an external power supply to the PCB board.

8. The wireless charger according to claim 7, wherein a shell surface of the bottom shell has a certain area, a side wall of the bottom shell has a certain height, the air inlet is arranged in the shell surface of the bottom shell and has a certain area, and the plurality of air outlets are arranged in the side wall of the bottom shell.

9. The wireless charger according to claim 7, wherein the wireless charger further comprises a magnet block, the magnet block is arranged between the face shell and the supporting plate, and the face shell and the supporting plate form a clamping force for the magnet block.

10. The wireless charger according to claim 9, wherein a barrier strip protrudes from one surface of the supporting plate, the charging coil is located on one side of the barrier strip and distributed close to a center of the supporting plate, and the magnet block is located on the other opposite side of the barrier strip and distributed close to the edge of the supporting plate; and the barrier strip is connected end to end to form a ring shape, and an outer coil side of the charging coil is clamped in the barrier strip.
